(19) United States
(12) Patent Application Publication
(10) Pub. No.: US 2006/0068761 A1
(43) Pub. Date: Mar. 30, 2006

(54) System and method for prioritizing a store-and-forward message

(75) Inventors: Michael Dwayne Chambers, Plainfield, IL (US); Cynthia Florkey, Chicago, IL (US); Ruth Schaefer Gayde, Naperville, IL (US)

Correspondence Address: DUFT BORNSEN & FISHMAN, LLP, 1526 SPRUCE STREET, SUITE 320, BOULDER, CO, 80302, US

(73) Assignee: Lucent Technologies Inc., Murray Hill, NJ (US)

(21) Appl. No.: 10/951,930

(22) Filed: Sep. 28, 2004

(51) Int. Cl. H04L 12/58; H04Q 7/38; H04Q 7/20

(52) U.S. Cl. 455/412.1; 455/414.1; 455/466

(57) ABSTRACT

Systems and methods are disclosed for prioritizing a store-and-forward message in a store-and-forward data communication system. A store-and-forward data communication system is provided according to an embodiment of the invention. The store-and-forward data communication system includes a priority system configured to generate a priority level for a store-and-forward message. The store-and-forward data communication system further includes a store-and-forward network that is configured to receive a request that requests priority processing and transmitting of the store-and-forward message, obtain the priority level from the priority system in response to the message request, and transmit the store-and-forward message according to the priority level.

### BACKGROUND OF THE INVENTION

1. Field of the Invention

The invention is related to the field of communications, and in particular, to systems and methods for store-and-forward messages.

2. Statement of the Problem

Many types of communication networks exist. A voice network, such as the telephone network, is designed to efficiently and reliably conduct voice communications, generally over switched links. Similarly, a data network is designed to efficiently and reliably conduct data communications through transmission of data packets, for example. Some examples of such data networks are paging networks and computer networks (such as the Internet). These communication networks are very useful and widespread.

However, there has been a need to send data messages over voice networks. For example, data networks usually require some manner of sign-on and verification process and local equipment availability in order to send or receive data messages, no matter how small the data message may be. This is inconvenient and in some situations it is totally unworkable. In addition, there is often a need to simultaneously transfer data between persons who are communicating over a voice network.

In response to this need, the Short Message Service (SMS) protocol was developed. The SMS protocol is one store-and-forward network, and it was designed primarily for text messaging over wireless voice communication networks. SMS allows the transmission of short, non-voice messages over a voice communication network. An SMS message comprises digital data, such as text, and is usually limited to no more than 160 text characters. In addition, an SMS message can be used to transmit digital data and can even be used, in a limited manner, to transmit graphics and video.

An SMS message is commonly transmitted using out-of-band signaling, such as by using the Signaling System 7 (SS7) network. The SMS operates on a store-and-forward basis, wherein an SMS message is transmitted to a Short Message Service Center (SMSC), which stores the SMS message and attempts to deliver the SMS message to the destination. Advantageously, a mobile telephone or mobile device can send or receive an SMS message at any time, even when a voice call is currently in progress.

FIG. 1 shows a prior art SMS system. The prior art SMS system includes a communication device, a Short Message Service Center (SMSC), an SMS Gateway/Interworking Mobile Switching Center (SMS G/IWMSC), an SS7 network, a Home Location Register (HLR), a Visitor Location Register (VLR), a Mobile Switching Center (MSC), and a Base-Station System (BSS). The communication device can comprise a portable or mobile communication device that is initiating and sending an SMS message. The SMSC receives the SMS message and stores and forwards the SMS message. The SMS G/IWMSC is an MSC that is capable of receiving an SMS message from the SMSC, querying the HLR and/or VLR for information regarding the location of the SMS message destination, and delivering the SMS message to a MSC corresponding to the destination communication device. The SS7 network is used to transport signaling messages for querying the HLR and/or the VLR. The MSC transfers the SMS message to the BSS (or other appropriate wireless network device), and the BSS relays the SMS message to the destination communication device.

A drawback of the SMS system of the prior art is that all SMS messages have the same priority. In the prior art, there is no allowance for emergency or high priority messages. There is provision in the SMS system for re-trying message transmission in the event of delivery failure. However, the delivery can be greatly delayed as a result. Therefore, during periods of high traffic, an SMS message may not get through to the destination or may be unacceptably delayed.

### SUMMARY OF THE SOLUTION

The invention solves the above and other related problems by providing message prioritization in a store-and-forward data communication network. The invention provides systems and methods for increasing the probability of message delivery for participating users during times of network congestion. Advantageously, a store-and-forward message can be transmitted according to an included priority level in order to provide priority treatment for selected store-and-forward messages. More particularly, network operators are able to provide a service for expeditious delivery of SMS messages for authorized National Security and Emergency Preparedness personnel who are responding to a disaster. In addition, the invention can decrease the delivery time for SMS messages for those individuals in the general public who subscribe to or are authorized to use this enhanced messaging service.

A store-and-forward data communication system is provided according to an embodiment of the invention. The store-and-forward data communication system comprises a priority system configured to generate a message priority level for a store-and-forward message. The store-and-forward data communication system further comprises a store-and-forward network that is configured to receive a request that requests priority processing and transmitting of the store-and-forward message, obtain the message priority level from the priority system in response to the request, and transmit the store-and-forward message according to the priority level.

A method for prioritizing a store-and-forward message in a store-and-forward data communication system is provided according to an embodiment of the invention. The method comprises receiving a request that requests priority processing and transmitting of the store-and-forward message, obtaining a priority level in response to the request, and processing and transmitting the store-and-forward message according to the priority level.

A method for prioritizing a store-and-forward message in a store-and-forward data communication system is provided according to an embodiment of the invention. The method comprises receiving a request that requests priority processing and transmitting of the store-and-forward message, generating a priority request for the store-and-forward message upon receipt of the request, with the priority request including one or more selection criteria, receiving a priority level in response to the priority request and according to the one or more selection criteria, and processing and transmitting the store-and-forward message according to the priority level.

The invention may include other exemplary embodiments described below.

### DESCRIPTION OF THE DRAWINGS

The same reference number represents the same element on all drawings.

FIG. 1 shows a prior art SMS system.

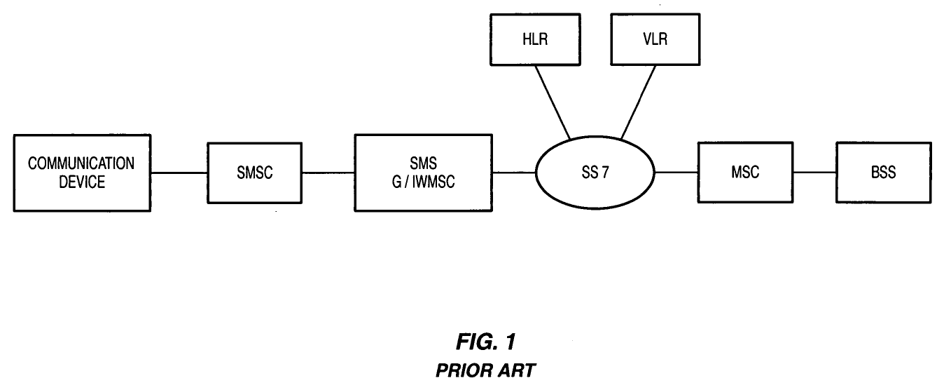

FIG. 2 illustrates a store-and-forward data communication system according to an embodiment of the invention.

FIG. 3 is a flowchart of a method for prioritizing a store-and-forward message in a store-and-forward system according to an embodiment of the invention.

FIG. 4 illustrates an SMS store-and-forward data communication system according to an embodiment of the invention.

FIG. 5 illustrates an SMS store-and-forward data communication system according to an embodiment of the invention.

### DETAILED DESCRIPTION OF THE INVENTION

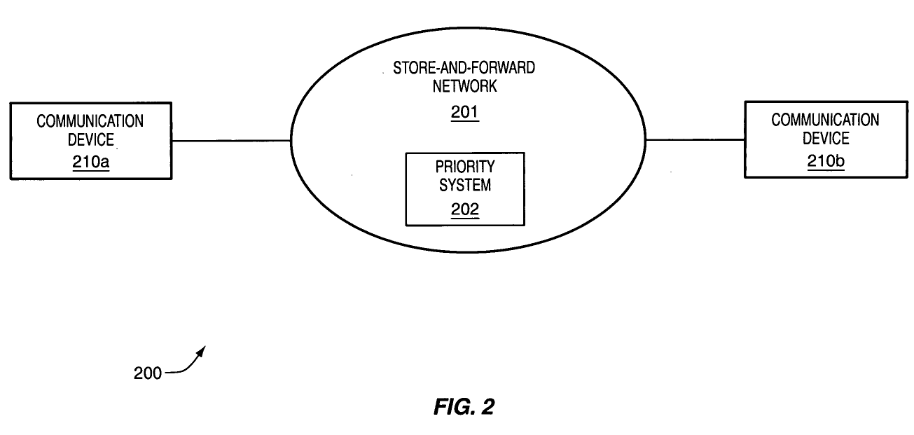

FIGS. 2-5 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

Store-and-Forward Data Communication System—FIG. 2

FIG. 2 illustrates a store-and-forward data communication system 200 according to an embodiment of the invention. The store-and-forward data communication system 200 can comprise a governmental service, can comprise a commercial service, etc. The store-and-forward data communication system 200 includes a store-and-forward network 201 and a priority system 202. The store-and-forward network 201 is used to transmit store-and-forward messages between a first communication device 210a and a second communication device 210b. The store-and-forward network 201 and the priority system 202 together can prioritize a store-and-forward message within the store-and-forward data communication system 200. The prioritizing of the messages can comprise prioritizing the processing of the messages within the store-and-forward network 201 and can comprise prioritizing the transmitting of the messages through the store-and-forward network 201. In this manner, the transmission of store-and-forward messages is streamlined and facilitated. In addition, message transmission is improved during times of network congestion. Furthermore, the system and method according to the invention enables the improved transmission of emergency messages or other high priority messages.

When the subscriber initiates a store-and-forward message in a communication device 210, the store-and-forward network 201 can access the priority system 202 and obtain a relevant priority level. A priority level (or levels) can be assigned to users of the store-and-forward data communication system 200. For example, an emergency communication device or emergency personnel can be assigned a high priority level. Consequently, all store-and-forward messages from the emergency communication device or from the emergency personnel will always have a high probability of successfully transferring a store-and-forward message on a first try.

A communication device 210 can comprise any manner of electronic communication device that is capable of sending and/or receiving store-and-forward messages. Some examples of a communication device 210 are mobile and cellular telephones, pagers, Internet telephony, including Session Initiation Protocol (SIP) telephones, for example, wireline telephones, Personal Digital Assistants (PDAs), text-to-speech devices, network-enabled computers, etc. A communication device 210 can comprise a mobile or fixed device, although store-and-forward protocols were initially designed primarily for mobile devices. It should be understood that other communication devices are contemplated and are within the scope of the description and claims.

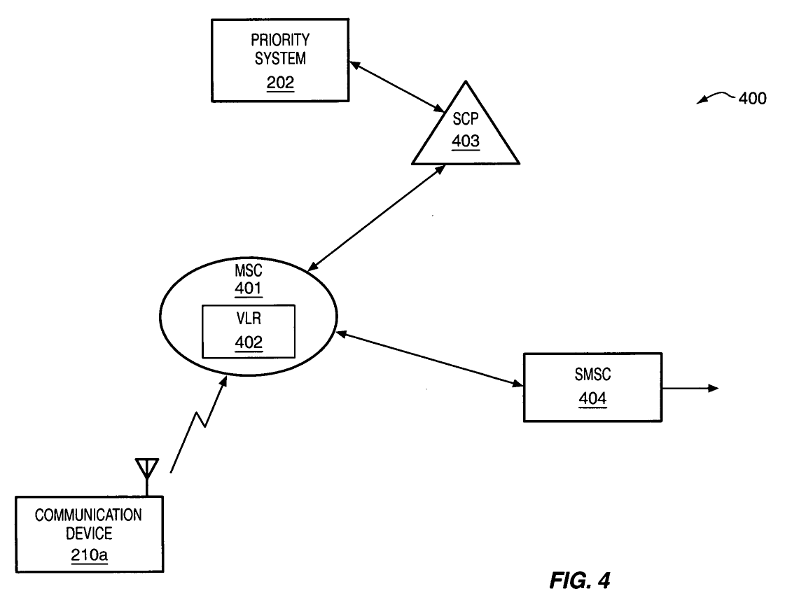

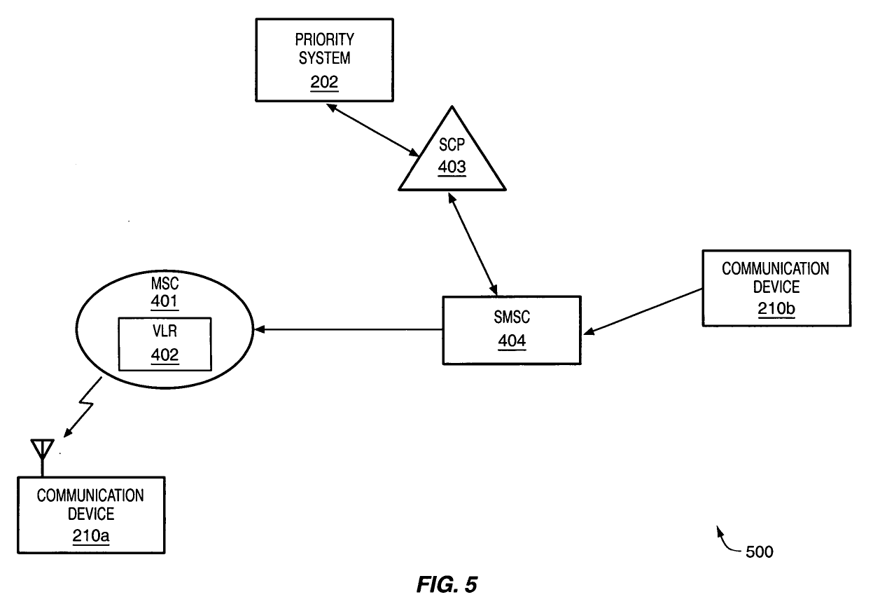

The store-and-forward network 201 can comprise any network that can implement a store-and-forward communication protocol. The Short Message Service (SMS) protocol is one example of a store-and-forward implementation. Other store-and-forward implementations include improvements or variations on SMS, include similar systems such as instant messaging systems, etc. Specific examples of SMS store-and-forward prioritization are discussed below in conjunction with FIGS. 4 and 5. However, it should be understood that the principles and methods of the invention can apply to any manner of store-and-forward network.

The priority system 202 can comprise any manner of database, storage system, etc., that can be used to store and retrieve priority information for the store-and-forward network 201. The priority system 202 can store one or more priority levels for each user or subscriber.

A priority level supplied by the priority system 202 can be provided according to one or more selection criteria included in a priority request. The selection criteria can include sender information. The selection criteria can include one or more of a communication device identity, a user or subscriber identity, a user or subscriber level (subscribers in some embodiments can pay for different priority levels, such as an elite messaging level, for example), an emergency personnel identity, a destination classification, or a governmental agency identity, for example. In addition, the selection criteria can include any manner of receiver information, similar to the sender information. Other selection criteria can also be employed, and are within the scope of the description and claims.

The priority system 202 can provide a priority level that is one of several levels. In one embodiment, the priority level comprises priority levels 1-5, consistent with the voice standard for the Wireless Priority Service (WPS) protocol. A CDMA WPS protocol is the Wireless Priority Service Enhancements for CDMA Systems, PN-30054 Reballot Version (to be published as TIA-917), Jul. 30, 2004, and is incorporated herein by reference. Another WPS protocol specification is the Wireless Priority Service (WPS) Industry requirements for the Full Operating Capability (FOC) for CDMA Based Systems—Home Location Register (HLR), Issue 1.0, Jun. 4, 2004, available on the web site “https://gets-ic-pmo.dyncsc.com”, and incorporated herein by reference. However, it should be understood that other priority levels and other priority schemes can be implemented as needed, and are within the scope of the description and claims.

The priority levels are populated in the priority system 202 for users, subscribers, communication devices, or entities that use the prioritization. In one embodiment, the priority levels are populated in the priority system 202 on a per-user basis at the time that the user subscribes to or is authorized for the priority service. For example, when a new user subscribes, a priority level (or levels) is added to the priority system 202 for the new subscriber. Alternatively, for non-subscribing users, such as emergency or governmental personnel, the priority level or levels can be added to the priority system 202 at any time, such as when new personnel are authorized to the store-and-forward system 200. However, other priority level initialization schemes can be employed, and are within the scope of the description and claims.

In one embodiment, the priority system 202 can provide a priority level only in an emergency state. For example, during times of non-emergency, priority levels are not assigned to store-and-forward messages or are not acted on by the store-and forward network 201. In this embodiment, prioritization is only performed when an emergency exists and where some manner of emergency flag, state, condition, etc., is declared in the store-and-forward data communication system 200.

The priority system 202 in one embodiment comprises a component of the store-and-forward network 201. Alternatively, the priority system 202 can comprise an external component or system, or can comprise a component of some other communication network (see the SCP 403 of FIGS. 4-5).

The prioritization of the store-and-forward message according to the invention can apply to a mobile-to-mobile communication device scenario. In addition, the invention can apply to a mobile-to-fixed communication device scenario or to a fixed-to-mobile communication device scenario. Further, the store-and-forward message according to the invention can apply to a fixed-to-fixed communication device scenario.

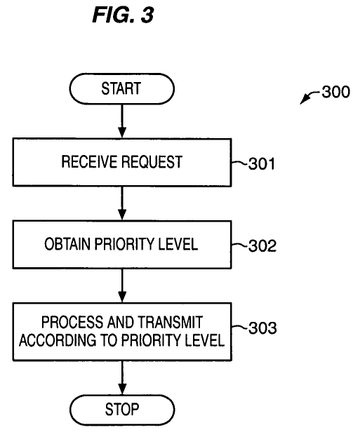

Method for Prioritizing a Store-and-Forward Message—FIG. 3

FIG. 3 is a flowchart 300 of a method for prioritizing a store-and-forward message in a store-and-forward system according to an embodiment of the invention. In step 301, the store-and-forward network 201 receives a request from a communication device 210, such as the communication device 210a or 210b. The request can comprise an SMS message and a request for a transmission priority. The SMS message and the request for the transmission priority can be separate messages or can comprise one combined message. The request comprises a request for a particular priority level and also comprises a request for a priority processing and transmitting of a store-and-forward message according to the priority level. The request can include some manner of priority request code. In one embodiment, the priority request can comprise a keycode entered by the user of the communication device 210, such as a “*272” keycode in one example. The “*272” keycode can comprise a call priority request in a WPS call origination request according to the Wireless Priority Service Enhancements for CDMA Systems specification, discussed above. Alternatively, the call priority request can be received in other ways and in other forms, as previously discussed. For example, in one embodiment a priority level can be assigned to a communication device or person, and can be looked up or obtained through any manner of user identifier, device identifier, etc.

In step 302, the store-and-forward network 201 obtains a priority level in response to the request. The store-and-forward network 201 communicates with the priority system 202 in order to obtain the priority level, as previously discussed. In one embodiment, the store-and-forward network 201 generates a priority request for the store-and-forward message upon receipt of the message request, transmits the priority request to the priority system 202, and receives the priority level from the priority system 202 in response to the priority request. In another embodiment, the store-and-forward network 201 generates a priority request for the store-and-forward message upon receipt of the request, with the priority request including one or more selection criteria, transmits the priority request to the priority system 202, and receives a priority level from the priority system 202 in response to the priority request and according to the one or more selection criteria.

In step 303, the store-and-forward message is processed and transmitted according to the priority level, including at all subsequent network nodes before the destination. If the store-and-forward message has a high priority level, the store-and-forward message can be transferred ahead of other waiting store-and-forward messages.

In one embodiment, the store-and-forward message comprises an SMS message. The SMS protocol is one store-and-forward protocol, so the priority level can be used in order to process and transfer higher priority SMS messages ahead of lower priority SMS messages.

SMS Store-and-Forward Data Communication System—FIG. 4

FIG. 4 illustrates an SMS store-and-forward data communication system 400 according to an embodiment of the invention. The figure is an example of a Mobile Originated (M-O) SMS message transaction according to an embodiment of the invention. The SMS store-and-forward data communication system 400 in this embodiment includes the priority system 202, a MSC 401 that includes at least a Visitor Location Register (VLR) 402, a Service Control Point (SCP) 403, and a Short Message Service Center (SMSC) 404. In this embodiment, the mobile communication device 210a initiates and transmits the SMS message to the MSC 401 through a mobile communication link, such as a wireless link.

Additional MSCs and other network components can be used by the SMSC 404 to complete the delivery of the prioritized SMS message. For example, the SMS store-and-forward data communication system 400 can further include an SMS Gateway/Interworking Mobile Switching Center (SMS G/IWMSC), a signaling network or communication network, such as a Signaling System 7 (SS7) network, a Home Location Register (HLR), and one or more Base-Station Systems (BSSs), for example. The SMS G/IWMSC is an MSC that is capable of receiving an SMS store-and-forward message from the SMSC, querying the HLR and/or VLR, performing gateway/interworking functions such as protocol translations, and delivering the SMS store-and-forward message to a MSC corresponding to the destination communication device. The SS7 network is used to perform the querying of the HLR and/or the VLR 402. One or more subsequent MSCs can be employed to transfer the prioritized message to a destination BSS, and the destination BSS relays the SMS message to the destination communication device.

In one embodiment, the communication device 210a initiates an SMS message by sending a request to the MSC 401. The request can comprise an SMS message that includes a request for a transmission priority. The request for transmission priority can comprise some manner of priority keycode, as previously discussed. The MSC 401 receives the SMS message request and recognizes the transmission priority request.

In one embodiment, the MSC 401 determines whether the user/originator is allowed to transmit a prioritized SMS message. For example, in some embodiments the requester must be a subscriber to the priority system or to a priority service. The MSC 401 in one embodiment verifies a user or subscriber's status (or other qualifying criteria) by accessing either the HLR or the VLR 402. If the MSC 401 is not the home MSC for the communication device 210a (i.e., there is no local HLR to access), then the MSC 401 can access the VLR 402. The VLR 402 may have previously obtained the subscriber's profile when the communication device 210a first arrived in the serving area of the MSC 401. The user's profile can contain all the information about the subscriber that the MSC 401 will need to process the message transaction. The subscriber's priority level can comprise part of this user profile.

The MSC 401 requests a priority level for the received message request. The priority request in one embodiment comprises a WPS protocol request. The WPS protocol can generally request priority level information in two ways. In a first way, when a WPS call is originated, the VLR 402 sends an ANSI-41 OriginationRequest to the SCP 403, with a WPSCallIndicator parameter included in the OriginationRequest. The WPSCallIndicator parameter comprises a voice call WPS command that obtains a voice call priority level that can be used for prioritizing store-and-forward messages. In a second way, if a subscriber profile is not available at the time of call origination, the VLR 402 sends an ANSI-41 QualificationRequest to the HLR.

The MSC 401 in one embodiment queries the SCP 403 in order to obtain the user or subscriber's priority level, wherein the SCP 403 accesses the priority system 202 in order to obtain the priority level. The priority system 202 can comprise any manner of local or remote data facility, such as a database, for example.

In the embodiment shown in the figure, the priority system 202 comprises a component of the SCP 403 or can communicate with the SCP 403. Alternatively, the priority level can be stored in the HLR of the user and consequently can be passed to the VLR 402 during a mobile registration procedure, as is known by those skilled in the art. This method can be used for M-O SMS message transactions. Additionally or alternatively, the priority level can be stored at the SMSC 404 or at both the SCP 403 and the SMSC 404. Storage at the SMSC 404 can be performed for Mobile Terminated (M-T) SMS message transactions. As a result, the priority system 202 can be queried by the serving MSC 401 for M-O SMS message transactions and can be queried by the SMSC 404 for M-T SMS message transactions.

The user or subscriber can be identified by a key such as a Mobile Directory Number (MDN) and/or an International Mobile Station Identity (IMSI). Therefore, the user or subscriber can also have a priority level associated with this key. If this information is stored in the SCP 403, for example, then the message to query the priority level presents the SCP 403 with the MDN or IMSI key so that the SCP 403 can look up the priority level for the subscriber.

When the priority level is received in the MSC 401, the MSC 401 passes the SMS message and the priority level to the SMSC 404 for delivery. If there is congestion (such as on the SS7 links between the MSC 401 and the SMSC 404), then the MSC 401 can queue the SMS message based on the subscriber's priority. As a result, there can be a priority transmission decision at the MSC 401, in addition to priority transmission decisions at the SMSC 404 and beyond.

The SMSC 404 receives the SMS message and the priority level. The SMSC 404 can store and forward the SMS message according to the priority level. In addition, the SMSC 404 can implement different delivery attempt frequencies based on the priority level. For example, the SMSC 404 can place an incoming highest priority SMS message at a top of a queue of SMS messages to be transmitted. Alternatively, the SMSC 404 can place an incoming highest priority SMS message in a highest priority queue level, along with other highest priority SMS messages.

The SMSC 404 can hold lower priority SMS messages until all high priority SMS messages are completed. Alternatively, the SMSC 404 can limit the amount of lower priority messages that are transmitted during periods when high priority messages are being transmitted. In another alternative, in some emergency situations the SMSC 404 can transmit only SMS messages of emergency priority levels, for example. The above operational processes will lessen the occurrence of retries, and will therefore increase the likelihood that a high priority SMS message will be delivered, and will increase the likelihood that it will be delivered without re-tries or without significant re-try delay.

SMS Store-and-Forward Data Communication System—FIG. 5

FIG. 5 illustrates an SMS store-and-forward data communication system 500 according to an embodiment of the invention. The figure is an example of a M-T SMS message transaction according to an embodiment of the invention. The SMS store-and-forward data communication system 500 in this embodiment includes the priority system 202, the MSC 401 and the VLR 402, the SCP 403, and the SMSC 404. It should be understood that additional network components, such as additional MSCs, can exist between the SMSC 404 and the MSC 401 of the figure. In this scenario, a non-mobile communication device 210b initiates and transmits the SMS message to the SMSC 404 through a non-mobile or land-based communication network link.

The land-based communication network can comprise any manner of non-mobile communication network, including switched networks and packet networks. In one embodiment, the network link can comprise an Internet link, wherein the communication device 210b is a web-based application or browser or is a network-enabled computer of some manner. However, other communication devices 210b are contemplated and are within the scope of the description and claims.

The communication device 210b initiates an SMS message by sending an SMS message request to the SMSC 404 in one embodiment. The request can comprise an SMS message that includes a request for a transmission priority, as previously discussed. The SMSC 404 receives the SMS message request and recognizes the transmission priority request. The SMSC 404 in this embodiment queries the SCP 403 to obtain the user or subscriber's priority level. As previously discussed, the SCP 403 can access the priority system 202 in order to obtain the priority level. The priority system 202 can comprise any manner of local or remote data facility, such as a database, for example. The priority system 202 can comprise a component of the SCP 403 or can communicate with the SCP 403.

Alternatively, the SMSC 404 can obtain the priority level for the user/subscriber beforehand, such as when a user/subscriber profile is created at the SMSC 404. In yet another alternative, the SCP 403 can transmit the priority information to the SMSC 404 when the user/subscriber profile is entered at the SCP 403 (after the SCP 403 queries the user's HLR for the user's home SMSC).

As before, the supplied priority level can be provided according to any selection criteria. The SMSC 404 can process and can store and forward the SMS message according to the priority level and can implement different delivery attempt frequencies based on the priority level, as previously discussed. When the priority level is received in the SMSC 404 from the SCP 403, the SMSC 404 passes the SMS message and the priority level to the MSC 401 for delivery. One or more priority transmission decisions are subsequently performed at the SMSC 404 and beyond.

In conclusion, a store-and-forward system and method as described in the embodiments herein advantageously prioritizes a store-and-forward message. In this manner, the transmission of store-and-forward messages is streamlined and facilitated. In addition, message transmission during times of network congestion is likewise improved. Furthermore, the system and method according to the invention enable improved transmission of emergency messages or other high priority messages.

We claim:

1. A store-and-forward data communication system, comprising:
a priority system configured to generate a priority level for a store-and-forward message; and
a store-and-forward network configured to receive the store-and-forward message, receive a request that requests priority processing and transmitting of the store-and-forward message, obtain the priority level from the priority system in response to the request, and process and transmit the store-and-forward message according to the priority level.

2. The store-and-forward data communication system of claim 1, wherein the store-and-forward data communication system comprises a Short Message Service (SMS) system.

3. The store-and-forward data communication system of claim 1, wherein the priority system stores one or more priority levels for a user.

4. The store-and-forward data communication system of claim 1, wherein the store-and-forward network queries a Service Control Point (SCP) for the priority level.

5. The store-and-forward data communication system of claim 1, wherein the store-and-forward network queries the priority system for the priority level through a Service Control Point (SCP).

6. The store-and-forward data communication system of claim 1, wherein the request includes one or more selection criteria.

7. The store-and-forward data communication system of claim 1, wherein the store-and-forward data communication system comprises a Short Message Service (SMS) system, the store-and-forward network includes a Short Message Service Center (SMSC) that processes and transmits the store-and-forward message according to the priority level.

8. The store-and-forward data communication system of claim 1, wherein the store-and-forward network includes a Mobile Switching Center (MSC) that processes and transmits the store-and-forward message according to the priority level.

9. The store-and-forward data communication system of claim 1, wherein the store-and-forward network includes a Home Location Register (HLR) that provides the priority level or wherein the store-and-forward network includes both the HLR and a Visitor Location Register (VLR) that provide the priority level.

10. The store-and-forward data communication system of claim 1, wherein the store-and-forward network includes a Short Message Service Center (SMSC) that provides the priority level.

11. The store-and-forward data communication system of claim 1, wherein the store-and-forward network includes a Mobile Switching Center (MSC) that obtains the priority level.

12. A method for prioritizing a store-and-forward message in a store-and-forward data communication system, the method comprising the steps of:
receiving the store-and-forward message;
receiving a request that requests priority processing and transmitting of the store-and-forward message;
obtaining a priority level in response to the request; and
processing and transmitting the store-and-forward message according to the priority level.

13. The method of claim 12, wherein the store-and-forward data communication system comprises a Short Message Service (SMS) system.

14. The method of claim 12, wherein the priority level is obtained from a priority system.

15. The method of claim 12, wherein the request includes a priority keycode.

16. The method of claim 12, wherein obtaining the priority level comprises:
generating a priority request for the store-and-forward message upon receipt of the request;
transmitting the priority request to a priority system; and
receiving the priority level from the priority system in response to the priority request.

17. The method of claim 12, wherein obtaining the priority level comprises:
generating a priority request for the store-and-forward message upon receipt of the request, with the priority request including one or more selection criteria;
transmitting the priority request to a priority system; and
receiving a priority level from the priority system in response to the priority request and according to the one or more selection criteria.

18. A method for prioritizing a store-and-forward message in a store-and-forward data communication system, the method comprising the steps of:
receiving the store-and-forward message;
receiving a request that requests priority processing and transmitting of the store-and-forward message;
generating a priority request for the store-and-forward message upon receipt of the request, with the priority request including one or more selection criteria;
receiving a priority level in response to the priority request and according to the one or more selection criteria; and
processing and transmitting the store-and-forward message according to the priority level.

19. The method of claim 18, wherein the store-and-forward data communication system comprises a Short Message Service (SMS) system.

20. The method of claim 18, wherein the one or more selection criteria comprises a priority keycode.
